(19) United States
(12) Patent Application Publication
(10) Pub. No.: US 2011/0171106 A1
(43) Pub. Date: Jul. 14, 2011

(54) VOC EMISSION CONTROL PROCESS AND SYSTEM

(75) Inventors: AYUMU YOKOYAMA, Clarkston, MI (US); Irving D. Bell, Wilmington, DE (US)

(73) Assignee: E. I. DU PONT DE NEMOURS AND COMPANY, Wilmington, DE (US)

(21) Appl. No.: 12/893,059

(22) Filed: Sep. 29, 2010

Related U.S. Application Data
(60) Provisional application No. 61/294,867, filed on Jan. 14, 2010.

(51) Int. Cl. C01B 31/20; B01J 19/00

(52) U.S. Cl. 423/437.1; 422/129; 422/198

(57) ABSTRACT

The present invention is directed to a process and a system for decomposing one or more volatile organic compounds (VOC) from a composition. This invention is particularly directed to a process and a system for decomposing one or more volatile organic compounds (VOC) from a coating composition. This invention is directed for reducing overall VOC emission from a composition, particularly from a coating composition.

### CROSS-REFERENCE TO RELATED APPLICATION

This application claims priority under 35 U.S.C. §119 from U.S. Provisional Application Ser. No. 61/294867 (filed Jan. 14, 2010), the disclosure of which is incorporated by reference herein for all purposes as if fully set forth.

### FIELD OF INVENTION

The present invention is directed to a process and a system for decomposing one or more volatile organic compounds (VOCs) from a composition. This invention is particularly directed to a process and a system for decomposing one or more volatile organic compounds (VOCs) from a coating composition.

### BACKGROUND OF INVENTION

Volatile organic compounds (VOCs) are compounds of carbon, which can emit into atmosphere and participate in atmospheric photochemical reactions. Many volatile organic compounds are commonly used in industrial products or processes, such as solvents, dispersants, carriers, coating compositions, molding compositions, cleaners, or aerosols. VOCs emitted into atmosphere, such as those emitted from coating compositions during coating manufacturing, application and curing process, can be related to air pollution impacting air quality, participate in photoreactions with air to form ozone, and contribute to urban smog and global warming.

Efforts have been made to reduce VOC emissions into the air. For example, the coating industry has been trying to develop low VOC coating compositions. VOC exempt organic compounds can also be used to substitute or replace part or all VOCs in some industrial applications, such as coatings. The VOC exempt organic compounds are compounds of carbon and are believed not to participate in atmospheric photochemical reactions to form smog. Examples of VOC exempt compounds can include acetone, methyl acetate, and PCBTF (Oxsol 100). However, production of low VOC products or converting naturally occurring volatile organic compounds into VOC exempt organic compounds can require the consumption of additional materials and energy, which may in turn cause further increase in net output of other materials such as carbon dioxide that has been attributed to global warming.

Therefore, an improved VOC emission control process or system is still needed.

### STATEMENT OF INVENTION

This invention is directed to a process for decomposing one or more volatile organic compounds (VOC) from a composition, said process comprising the steps of:

a) providing content data of the composition, said content data comprise data of said one or more volatile organic compounds; and

b) providing operation conditions for decomposing said one or more volatile organic compounds using a decomposer based on said content data.

This invention is further directed to a process for decomposing one or more volatile organic compounds (VOC) from a composition, said process comprising the steps of:

a) determining operation conditions of a decomposer for decomposing said one or more volatile organic compounds; and

b) formulating said composition based on said operation conditions.

This invention is further directed to a process for decomposing one or more volatile organic compounds (VOC) from a composition, said process comprising the steps of:

a) receiving operation conditions for decomposing said one or more volatile organic compounds using a decomposer based on said content data;

b) receiving said composition formulated according to said operation conditions;

c) collecting the one or more volatile organic compounds from said composition; and

d) decomposing said one or more volatile organic compounds in said decomposer under said operation conditions.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including every value between the minimum and maximum values.

As used herein:

The term “volatile organic compound”, “VOC”, “volatile organic compounds”, or “VOCs” refers to organic chemical compounds of carbon that can vaporize and enter the atmosphere and participate in atmospheric photochemical reactions. VOCs can be naturally occurring or produced from natural or synthetic materials. Some or all VOCs can be regulated under local, national, regional, or international authorities.

The term “exempt solvent”, “VOC exempt organic compounds”, “exempt organic compounds”, or “exempt VOC” refers to organic compounds that are exempt from regulations under one or more local, national, regional, or international authorities based on definitions, criteria, regulations, laws, or guidelines set forth by corresponding authorities. Typical exempt organic compounds can have negligible photochemical reactivity. Examples of exempt organic compounds in the United States can include acetone, methane, ethane, dimethyl carbonate, and propylene carbonate.

The term “coating” or “coating composition” can include any coating compositions known to or developed by those skilled in the art and can include a two-pack coating composition, also known as “2K coating composition”; a one-pack or 1K coating composition; a coating composition having a crosslinkable component and a crosslinking component; a radiation curable coating composition, such as a UV curable coating composition or an E-beam curable coating composition; a mono-cure coating composition; a dual-cure coating composition; a lacquer coating composition; a waterborne coating composition or aqueous coating composition; a solvent borne coating composition; or any other coating compositions known to or developed by those skilled in the art. The coating composition can be formulated as a primer, a basecoat, or a color coat composition and can comprise dyes, pigments or effect pigments. The coating composition can also be formulated as a clearcoat composition. Clearcoat composition can further comprise certain pigments having same or similar optical properties, such as same or similar refractive index as the cured clearcoat. One of such pigments can be transparent silica. A coating composition can comprise one or more volatile organic compounds (VOCs).

The term “vehicle”, “automotive”, “automobile” or “automotive vehicle” can include an automobile, such as car, bus, truck, semi truck, pickup truck, SUV (Sports Utility Vehicle); tractor; motorcycle; trailer; ATV (all terrain vehicle); heavy duty mover, such as, bulldozer, mobile crane and earth mover; airplanes; boats; ships; and other modes of transport.

A coating composition can be applied over a surface of a substrate to form a coating layer using coating application techniques such as spraying, brushing, rolling, draw down, or any other coating application techniques known to or developed by those skilled in the art. The coating composition can comprise VOCs. Additional organic solvents, such as VOCs the same or different from what are already in the coating composition, can be added to the coating composition for modifying properties such as viscosity, rehology, drying time, sagging, appearance, or other properties of the coating or coating composition. The coating layer can be cured or dried to form a dry coating layer at room temperatures, also known as ambient temperatures, such as a temperature in a range of from 15° C. to 60° C., or at elevated temperatures, such as a temperature in a range of from 60° C. to 300° C.

Typically, the VOCs in coating compositions can be emitted from the coating compositions during manufacturing, preparation, application, curing or drying process. The emitted VOCs can be collected, for example, in a spray booth, or an enclosure such as a curing chamber or a baking facility.

This invention is directed to a process for decomposing one or more volatile organic compounds (VOCs) from a composition. The process can comprise the steps of:

a) obtaining content data of the composition, said content data comprise data of said one or more volatile organic compounds; and

b) obtaining operation conditions for decomposing said one or more volatile organic compounds using a decomposer based on said content data

The content data can comprise data on chemical nature, quantity, or a combination thereof of the composition including those of the volatile organic compounds. In one example, the content data can comprise names and quantities of components of a coating composition. In another example, the content data can comprise data on VOCs' chemical nature, quantity, vapor pressure, density, volatility, flash point, reactivity to other materials, effects on human or animals, toxicity to catalysts, corrosion effect to metals, or a combination thereof. Other data that are known to or determined to be relevant by those skilled in the art can also be included. The content data can be obtained from a manufacturer of the composition; one or more content data providers; one or more public or private data collections, such as a public or private database, library, archive, books, or any public or private data sources; or by determining the composition content through one or more analytical processes, such as calculation of theoretical properties of a chemical compound, or determining chemical nature of the composition via analyses or experiments. Typically, the content data can be obtained from a manufacturer of the composition.

The operation conditions can include reactor temperature, residence time (the time VOCs in the reactor), pre-heating temperature, catalyst for decomposition, absorption material, piping material for collecting or transporting the VOCs, flow rate of the VOCs, flow rate of the air, flow rate of the VOCs mixed with air or other gases, or a combination thereof. Additional operation conditions, such as cooling conditions, piping size and configuration, or other operation conditions that are necessary for operating the decomposer, can also be included. The operation conditions can be obtained from a manufacturer of the decomposer; one or more operation condition data providers; one or more public or private data collections, such as a public or private database, library, archive, books, or any public or private data sources; or through one or more testing processes.

The process can further comprise the step of:

c) obtaining selection data for selecting said decomposer to decompose said one or more volatile organic compounds based on said content data.

The selection data can comprise specifications of one or more decomposers, the suitability of the decomposers for decomposing specific types of VOCs, process capability of the decomposers, size of the decomposers, costs of hardware of the decomposers, costs and requirements of installations of the decomposers, costs and requirements of maintaining and running the decomposers, energy consumptions of the decomposers, regulations and requirements of local authorities on the use of the decomposers, configurations of the decomposers, or a combination thereof. In one example, the selection data can comprise process capability of a decomposer for decomposing VOC gases, such as air-VOCs mix, having VOCs in a certain range of concentrations; size limitation for installation space; cost limitations on hardware, installation, maintenance, etc; and energy consumption limitations. In another example, selection data can comprise process capability of a decomposer for decomposing chlorinated VOCs (CI-VOCs). The selection data can be obtained from a manufacturer of the decomposer; a manufacturer of the composition; one or more operation condition data providers; one or more public or private data collections, such as a public or private database, library, archive, books, or any public or private data sources; or through one or more testing processes.

The process can further comprise the steps of:

d) collecting the one or more volatile organic compounds from said composition; and

e) decomposing said one or more volatile organic compounds in said decomposer under said operation conditions.

The VOCs can be collected through filters, absorbents, pipes, ducts, or other instruments or devices. Typically, the VOCs can be emitted into the air. For example, VOCs in a coating composition can be emitted into the air during coating preparation, spraying or curing. The air containing the VOCs, can be forced through one or more collection paths, such as pipes, ducts, or other instruments or devices. In one example, a coating composition is applied in a spray booth. The VOCs can emit into the air forming an air-VOC mix which can occur during coating preparation, spraying or curing. In one example, the air-VOC mix can be collected through the spray booth exhaust system. The VOCs or the air-VOC mix can be concentrated before decomposition. Examples for VOC concentration can include filtration, absorption, desorption, condensation, or a combination thereof. Processes and devices known to those skilled in the art can be used to concentrate VOCs, prior or during VOC decomposition.

The VOCs can be decomposed into end products comprising carbon dioxide and water in the selected decomposer by oxidation, such as thermal oxidation, catalytic oxidation; catalytic conversion; electromagnetic conversion, or a combination thereof. The VOCs can be decomposed at temperatures in a range of from 50° C. to 3000° C. The decomposer can be selected from a thermal decomposer, a catalytic decomposer, a plasma decomposer, a microwave decomposer, or a combination thereof. The decomposer can have one or more reactors and one or more accessories. A thermal decomposer can comprise one or more thermal reactors and can decompose VOCs in the presence of thermal energy. The thermal reactors can be a furnace, chamber, turbine, internal combustion engine, or other types of reactors for oxidation at elevated temperatures. Initial thermal energy or fuel can be provided for initiating decomposition. Typically, the air-VOCs mix can be heated to a certain range of temperature in order for decomposition reaction to initiate. Once initiated, decomposition of VOCs can release more thermal energy that can be used to decompose further VOCs or discharged as output energy. A catalytic decomposer can comprise one or more catalytic reactors and can decompose VOCs in the presence of one or more catalysts. Catalytic decomposers can operate at a wide range of temperatures depending on catalysts used. A plasma decomposer can comprise one or more plasma reactors and a source of plasma energy, and can decompose VOCs in the presence of the plasma energy. A microwave decomposer can comprise one or more microwave reactors and a source of microwave energy, and can decompose VOCs in the presence of the microwave energy. The thermal, plasma or microwave decomposers can also comprise one or more catalysts. A decomposer can also comprise a reactor that can use a combination of aforementioned energy sources or a combination of catalysts and energy sources. A decomposer can further comprise one or more reactors using different energy sources, for example from the energy source selected from thermal, plasma, and microwave. The decomposer can be configured in-line or off-line, and each can be operated in a continuous or a batch mode.

Thermal oxidation of VOCs can occur at certain temperatures in the presence or in the absence of one or more catalysts. Typically, thermal oxidation decomposition of VOCs can occur at temperatures 700° C. or higher. Oxidation can also occur at lower temperatures, such as in a range of from 100° C. to 700° C., in the presence of one or more catalysts. VOCs can also be oxidized by microwave energy in the presence of catalysts. Examples of catalysts can include noble metals, such as platinum or palladium; metal or non-metal oxides, or mixed oxides, such as titanium oxide, chromites of copper, barium hexaaluminate; and other metal catalysts, such as bimetallic chromium-copper.

The process can further comprise the steps of: f) collecting output energy from the decomposer. The process can further comprise the step of transfer said output energy to a thermal medium. The thermal medium can include water, oil, air, gas, gas mixture, or a combination thereof. The output energy can be used to pre-heat air-VOCs mix before entering a decomposer or a reactor. The output energy can also be used to provide thermal energy for decomposing VOCs in the same or different decomposer or reactor. The output energy can also be transformed into energy that is different form the output energy. For example, output energy in thermal form can be transformed into electricity, and vise versa. In one example, thermal output energy can be used to heat a space or to preheat incoming VOCs. In another example, the output energy can be transferred to water to produce heated water. In yet another example, the output energy can be transferred to water to produce steam for generating electricity. In yet another example, the output energy can be used to power fuel cells to produce electricity. In yet another example, the output energy can be used to power a turbine. In yet another example, the output energy can be used to power an engine, such as an internal combustion engine.

The process can further comprise the steps of obtaining estimated energy output data of the one or more volatile organic compounds, wherein the estimated energy output data are calculated based on the content data and the operation conditions. The estimated energy output data can be obtaining from a manufacturer of the decomposer; a manufacturer of the composition; one or more operation condition data providers; one or more public or private data collections, such as a public or private database, library, archive, books, or any public or private data sources; or through one or more calculation, testing or analytical processes. The estimated energy output data can also comprise energy consumption data for the decomposer. In one example, estimated energy output data can be calculated based on weight percentage of VOCs in a coating composition and theoretical energy content of the VOCs. In another example, estimated energy output data can be calculated based on weight percentage of VOCs in a similar coating composition and theoretical energy content of the VOCs. In another example, estimated energy output data can be obtained based on historical energy output data from similar VOC containing compositions decomposed in a decomposer. In yet another example, estimated energy output data can be measured by decomposing a sample of a VOC containing composition in a decomposer. In yet another example, estimated energy output data can be calculated based on energy output from the VOCs to be decomposed and the energy consumption for initiating and maintaining the VOCs' decomposition.

The process of this disclosure can further comprise the step of obtaining financial support for decomposing the one or more volatile organic compounds in the decomposer under the operation conditions. The financial support can comprise financial support for obtaining, installation, maintenance, or operation of the decomposer, accessories of the decomposer, or other software or hardware of the decomposer and its supporting system. The financial support can be in the forms of credit, loan, financial guarantee, cash advance, offset of debts, or any other forms of financial support. The financial support can be obtained from a manufacturer of the decomposer; a manufacturer of the composition, such as a coating manufacturer; one or more individuals; one or more commercial entities; one or more financial institutions, such as banks, credit unions, or other public or private financial entities or institutions.

In another embodiment of the invention, the process can comprise the steps of:

a) determining operation conditions of a decomposer for decomposing the one or more volatile organic compounds (VOCs); and

b) formulating the composition based on said operation conditions.

The process can further comprise the step of:

c) providing content data of said composition, said content data comprise data of said one or more volatile organic compounds.

The process can further comprise the step of providing financial support for decomposing said one or more volatile organic compounds in said decomposer under said operation conditions as described above.

The process can further comprise the step of providing modified operation conditions for decomposing said one or more volatile organic compounds using said decomposer based on said content data. Any of the aforementioned operation conditions can be modified. The modified operation conditions can include the use of catalysts that are not sensitive to the CI-VOCs, or operation temperatures that can reduce catalysts' sensitive to CI-VOCs. In one example, based on the operation conditions, the decomposer can have limited capability for decomposing CI-VOCs. The modified operation conditions can include a pre-treatment absorption system for reducing or removing CI-VOCs in the air-VOC mix. In another example, decomposing temperature can be modified to reduce toxicity effect of the CI-VOCs. In yet another example, a different catalyst can be used that is not sensitive to the toxicity effect of CI-VOCs. One example of such catalysts can include MnCuOx/TiO2 supported catalyst that can have no catalyst deactivation at temperatures over 350° C., and chromia-based catalysts or nanostructured chromia catalysts that are resistance to CI-VOCs' deactivation.

The process can further comprise the steps of:

d) collecting the one or more volatile organic compounds from said composition; and

e) decomposing said one or more volatile organic compounds in said decomposer under said operation conditions.

The process can further comprise the step of:

f) collecting output energy from said decomposer.

The process can further comprise the step of transferring said output energy to a thermal medium. As described above, the process can further comprise the steps of providing estimated energy output data of said one or more volatile organic compounds, wherein said estimated energy output data are calculated based on said content data and said operation conditions.

The process can further comprise the step of providing financial support for decomposing said one or more volatile organic compounds in said decomposer under said operation conditions, as describe above.

The decomposer can be selected from a thermal decomposer, a catalytic decomposer, a plasma decomposer, or a combination thereof.

The composition can be a coating composition.

One advantage of this invention is that one or more compositions can be formulated based on operation conditions of a decomposer. It is known that some VOCs, such as aforementioned chlorinated VOCs (CI-VOCs) can be toxic to some catalysts including metal catalysts. By determining operation conditions of the decomposer, such as the catalysts used, temperature range, piping materials, a composition can be formulated to reduce harmful effect to the decomposer and the accessories, therefore optimizing decomposition reactions. In one example, non-chlorinated VOCs can be formulated into the composition to replace or substitute part or all of the CI-VOCs to reduce the toxicity effect to catalysts.

Additional advantages of this invention can include the process for providing modified operation conditions for decomposing the VOCs based on the content data of the composition. As described above, the modified operation conditions can comprise steps of removing toxic VOCs such as CI-VOCs, using CI-VOC resistant catalysts, operating under conditions such as temperatures that provide catalyst resistant to toxic VOCs, or a combination thereof.

In a further embodiment, the process for reducing emission of one or more volatile organic compounds (VOCs) from a composition can also comprise the steps of:

a) obtaining operation conditions for a decomposer based on content data of said composition;

b) releasing said one or more volatile organic compounds from said composition in a releasing enclosure;

c) collecting said one or more volatile organic compounds released from said composition in said release enclosure; and

d) reducing emission of said one or more volatile organic compounds by decomposing said one or more volatile organic compounds in said decomposer under said operation conditions.

In yet another embodiment, the process for decomposing one or more volatile organic compounds (VOC) from a composition can comprise the steps of:

a) receiving operation conditions for decomposing said one or more volatile organic compounds using a decomposer based on said content data;

b) receiving said composition formulated according to said operation conditions;

c) collecting the one or more volatile organic compounds from said composition; and

d) decomposing said one or more volatile organic compounds in said decomposer under said operation conditions.

The composition can be a coating composition. The one or more volatile organic compounds can be collected from the composition during application or curing of the composition.

This invention is further directed to a system for decomposing one or more volatile organic compounds (VOC) from a composition. The system can comprise:

a) a release enclosure for releasing said one or more volatile organic compounds from said composition;

b) a collection means for collecting said one or more volatile organic compounds released from said composition in said release enclosure; and

c) a decomposer for decomposing said one or more volatile organic compounds;

wherein said decomposer receives said one or more volatile organic compounds from said collection means and is operated under operation conditions based on content data of said composition.

The decomposer can be a thermal decomposer, a catalytic decomposer, a plasma decomposer, or a combination thereof. The decomposer can be connected via one or more connecting channels to the collection means and said release enclosure. The release enclosure can be a coating spray booth. The decomposer can receive the one or more volatile organic compounds from said collection means continuously or in one or more batches.

Although coating compositions are specifically described or embodied in this disclosure, this invention can be suitable for other compositions comprising one or more VOCs. Examples of the compositions can include surface cleanings, solvent or solvent blends, polymer compositions or dispersions, aerosol compositions, or any other compositions comprising VOCs.

This invention provides advantages for using conventional VOCs in compositions and, in the same time, reducing VOC emission by providing a VOC emission control process, system, or a combination thereof.

What is claimed is:

1. A process for decomposing one or more volatile organic compounds (VOC) from a composition, said process comprising the steps of:
a) obtaining content data of the composition, said content data comprise data of said one or more volatile organic compounds; and
b) obtaining operation conditions for decomposing said one or more volatile organic compounds using a decomposer based on said content data.

2. The process of claim 1 further comprising the step of:
c) obtaining selection data for selecting said decomposer to decompose said one or more volatile organic compounds based on said content data.

3. The process of claim 1 further comprising the steps of:
d) collecting the one or more volatile organic compounds from said composition; and
e) decomposing said one or more volatile organic compounds in said decomposer under said operation conditions.

4. The process of claim 3 further comprising the steps of:
f) collecting output energy from said decomposer.

5. The process of claim 4 further comprising the step of transfer said output energy to a thermal medium.

6. The process of claim 1 further comprising the steps of obtaining estimated energy output data of said one or more volatile organic compounds, wherein said estimated energy output data are calculated based on said content data and said operation conditions.

7. The process of claim 1 further comprising the step of obtaining financial support for decomposing said one or more volatile organic compounds in said decomposer under said operation conditions.

8. The process of claim 1, wherein said decomposer is selected from a thermal decomposer, a catalytic decomposer, a plasma decomposer, a microwave decomposer, or a combination thereof.

9. The process of claim 1, wherein said composition is a coating composition.

10. A process for decomposing one or more volatile organic compounds (VOC) from a composition, said process comprising the steps of:
a) determining operation conditions of a decomposer for decomposing said one or more volatile organic compounds; and
b) formulating said composition based on said operation conditions.

11. The process of claim 10 further comprising the step of:
c) providing content data of said composition, said content data comprise data of said one or more volatile organic compounds.

12. The process of claim 10 further comprising the step of providing financial support for decomposing said one or more volatile organic compounds in said decomposer under said operation conditions.

13. The process of claim 10 further comprising the step of providing modified operation conditions for decomposing said one or more volatile organic compounds using said decomposer based on said content data.

14. The process of claim 13, wherein said modified operation conditions comprise steps of removing CI-VOCs, using CI-VOC resistant catalysts, operating at temperatures that provide catalyst resistant to CI-VOCs, or a combination thereof.

15. The process of claim 10 further comprising the steps of:
d) collecting the one or more volatile organic compounds from said composition; and
e) decomposing said one or more volatile organic compounds in said decomposer under said operation conditions.

16. The process of claim 15 further comprising the step of:
f) collecting output energy from said decomposer.

17. The process of claim 16 further comprising the step of transferring said output energy to a thermal medium.

18. The process of claim 10 further comprising the steps of providing estimated energy output data of said one or more volatile organic compounds, wherein said estimated energy output data are calculated based on said content data and said operation conditions.

19. The process of claim 10 further comprising the step of providing financial support for decomposing said one or more volatile organic compounds in said decomposer under said operation conditions.

20. The process of claim 10, wherein said decomposer is selected from a thermal decomposer, a catalytic decomposer, a plasma decomposer, or a combination thereof.

21. The process of claim 10, wherein said composition is a coating composition.

22. A process for decomposing one or more volatile organic compounds (VOC) from a composition, said process comprising the steps of:
a) receiving operation conditions for decomposing said one or more volatile organic compounds using a decomposer based on said content data;
b) receiving said composition formulated according to said operation conditions;
c) collecting the one or more volatile organic compounds from said composition; and
d) decomposing said one or more volatile organic compounds in said decomposer under said operation conditions.

23. The process of claim 22, wherein said one or more volatile organic compounds are collected from said composition during application or curing of said composition.

24. The process of claim 22, wherein said composition is a coating composition.

25. A system for decomposing one or more volatile organic compounds (VOC) from a composition, said system comprising:
a) a release enclosure for releasing said one or more volatile organic compounds from said composition;
b) a collection means for collecting said one or more volatile organic compounds released from said composition in said release enclosure; and
c) a decomposer for decomposing said one or more volatile organic compounds;
wherein said decomposer receives said one or more volatile organic compounds from said collection means and is operated under operation conditions based on content data of said composition.

26. The system of claim 25, wherein said decomposer is a thermal decomposer, a catalytic decomposer, a plasma decomposer, or a combination thereof.

27. The system of claim 25, wherein said decomposer is connected via one or more connecting channels to said collection means and said release enclosure.

28. The system of claim 25, wherein said release enclosure is a coating spray booth.

29. The system of claim 25, wherein said decomposer receives said one or more volatile organic compounds from said collection means in one or more batches.

30. A process for reducing emission of one or more volatile organic compounds (VOC) from a composition, said process comprising the steps of:
a) obtaining operation conditions for a decomposer based on content data of said composition;
b) releasing said one or more volatile organic compounds from said composition in a releasing enclosure;
c) collecting said one or more volatile organic compounds released from said composition in said release enclosure; and
d) reducing emission of said one or more volatile organic compounds by decomposing said one or more volatile organic compounds in said decomposer under said operation conditions.

31. The process of claim 30, wherein said composition is a coating composition.
